(19) United States
(12) Patent Application Publication
(10) Pub. No.: US 2014/0150828 A1
(43) Pub. Date: Jun. 5, 2014

(54) Method for Cleaning Metals, Oils, and Solvents from Contaminated Wipers, Cloths, Towels, and the Same

(71) Applicant: Valentine Asongu Nzengung, Lawrenceville, GA (US)

(72) Inventor: Valentine Asongu Nzengung, Lawrenceville, GA (US)

(21) Appl. No.: 13/692,115

(22) Filed: Dec. 3, 2012

(51) Int. Cl. B08B 3/04

(52) U.S. Cl. CPC B08B 3/044
USPC 134/34; 588/313

(57) ABSTRACT

Method for cleaning metals and organic solvents adsorbed to tissues. Soiled tissues are placed into a container or specially designed collection and cleaning container. An aqueous reagent formulation solution, not to exceed 15% of reagent in water on mass-mass basis is prepared. The required concentration of reagent as a function of the type and level of contamination of the tissues and the contaminants of concern to be cleaned is determined. The reagent solution of desired concentration to the soiled tissues in the container is then added. The dissolved reagent and soiled tissues are mechanically mixed to create intimate contact at ambient or above ambient temperatures. The container is sealed allowing the cleaning to occur for a period of time. Testing for metals and organics solvents are performed to confirm that the metals are stabilized/immobilized and the volatile organics are degraded. The tissues are then dried for reuse, recycling, or disposal.

### CROSS REFERENCE TO RELATED APPLICATIONS

Not Applicable

This application claims priority from U.S. Patent Application Ser. No. 61/741,688, entitled “Method for Cleaning Metals, Oils, and Solvents Contaminated Wipers, Cloths, Towels, and Same”, filed on 26-Jul.-2012. The benefit under 35 USC §119(e) of the United States provisional application is hereby claimed, and the aforementioned application is hereby incorporated herein by reference.

### FEDERALLY SPONSORED RESEARCH

Not Applicable

### SEQUENCE LISTING OR PROGRAM

Not Applicable

### TECHNICAL FIELD OF THE INVENTION

The present invention relates generally to de-contamination or cleaning methods. More specifically, the present invention relates to a method for properly cleaning contaminated tissues of F-listed solvents so they can be converted into decontaminated products suitable for disposal as non-hazardous waste or clean enough for reuse or recycling.

### BACKGROUND OF THE INVENTION

Durable wipers, cloths, industrial wipers, and towels (cleaning tissues) are manufactured with different types of materials (e.g., cellulose, cotton, synthetic fiber or a combination of these materials) for industrial shop use. The cleaning tissues are used in typical industrial operations to clean-up industrial oil and solvent spills, machine parts, equipment, etc. The cleaning process may cause the tissues to accumulate significant amounts of lubricating oil, petrochemicals, metals, and various organic solvents classified as hazardous waste. Following their use, the common practice is for the soiled cellulosic wipers to be disposed while the soiled cotton wipers are washed with detergent prior to reuse.

There are many F-listed solvents that are ineligible for municipal or other non-hazardous landfill disposal, including: 2-nitropropane, nitrobenzene, methyl ethyl ketone (MEK), methyl propyl ketone (MPK), isopropyl alcohol, methylene chloride, phenols (pyridine, cresol), benzene, cresols (o,m,p), carbon tetrachloride, chlorobenzene, tetrachloroethylene, trichloroethylene, toluene, and acetone. The manufacturers, distributors and end users of the different types of tissues are seeking solutions to decontaminate the soiled tissues so they meet the criteria for disposal as non-hazardous waste by their customers at lower cost, or are clean enough for reuse and recycle.

To date, nothing in the prior art discloses or teaches a method for properly treating contaminated tissues of F-listed solvents so they can be converted into decontaminated products suitable for disposal as non-hazardous waste or clean enough for reuse or recycling. The method of the present invention solves this shortcoming in the prior art.

### SUMMARY OF THE INVENTION

Methods for cleaning soiled tissues of various compositions for reuse, recycle, or disposal as non-hazardous waste. During the cleanup process a reaction between the metals and sulfur oxides (e.g., buffered hydrosulfite, persulfate) stabilizes the adsorbed metals as the insoluble metal sulfides, rendering the metals non-bioavailable. The oils and organic solvents are transformed/degraded to lower molecular weight by-products (organic anions and carbon dioxide) that are non-toxic.

Soiled tissues are placed into a container or specially designed collection and cleaning container. An aqueous reagent formulation solution, not to exceed 15% of reagent in water on mass-mass basis is then prepared. The required concentration of reagent as a function of the type and level of contamination of the tissues and the contaminants of concern to be cleaned is then determined. The reagent solution of desired concentration to the soiled tissues in the container is then added. The dissolved reagent and soiled tissues are mechanically mixed to create intimate contact. The container is sealed allowing the cleaning to occur for a period of time. A Toxicity Characteristic Leaching Procedure (TCLP) for metals and organics solvents or other required tests are performed to confirm that the metals are stabilized/immobilized and the volatile organics are degraded. The tissues are then rinsed with clean water and dried for reuse or recycling or disposed of a non-hazardous waste.

### BRIEF DESCRIPTION OF THE DRAWINGS

The accompanying drawings, which are incorporated herein and form a part of the specification, illustrate the present invention and, together with the description, further serve to explain the principles of the invention and to enable a person skilled in the pertinent art to make and use the invention.

FIG. 1 is a flow chart illustrating the steps of the method of the present invention;

FIG. 2 is a table showing the experimental results of composite tissues treated with 15% hydrosulfite solution at alkaline pH for 72 hours;

FIG. 3. is a table showing the experimental cleaning results for Methyl Ethyl Ketone (MEK) contaminated wipers with different formulations of reagents with the goal of complete elimination of Methyl Ethyl Ketone (MEK) through oxidative destruction;

FIG. 4 is a table showing the cleaning of benzene and toluene contaminated industrial wipers and associated experimental results; and

FIG. 5 is a table showing the results of cleaning Methyl Ethyl Ketone (MEK) contaminated wipers with persulfate formulations enhanced with titanium oxides.

### DETAILED DESCRIPTION OF THE INVENTION

In the following detailed description of the invention of exemplary embodiments of the invention, reference is made to the accompanying drawings (where like numbers represent like elements), which form a part hereof, and in which is shown by way of illustration specific exemplary embodiments in which the invention may be practiced. These embodiments are described in sufficient detail to enable those skilled in the art to practice the invention, but other embodiments may be utilized and logical, mechanical, electrical, and other changes may be made without departing from the scope of the present invention. The following detailed description is, therefore, not to be taken in a limiting sense, and the scope of the present invention is defined only by the appended claims.

In the following description, numerous specific details are set forth to provide a thorough understanding of the invention. However, it is understood that the invention may be practiced without these specific details. In other instances, well-known structures and techniques known to one of ordinary skill in the art have not been shown in detail in order not to obscure the invention. Referring to the figures, it is possible to see the various major elements constituting the apparatus of the present invention.

Now referring to the Figures, the method and experimental data results for the method for cleaning metals, oils, and solvents contaminated wipes, cloths, towels and the same are shown.

The present invention describes methods for cleaning soiled tissues of various compositions for reuse, recycle, or disposal as non-hazardous waste. During the cleanup process a reaction between the metals and sulfur oxides (e.g., buffered hydrosulfite, persulfate) stabilizes the adsorbed metals as the insoluble metal sulfides, rendering the metals non-bioavailable. The oils and organic solvents are transformed/degraded to lower molecular weight by-products (organic anions and carbon dioxide) that are non-toxic.

For example, trichloroethylene and tetrachloroethylene are reductively transformed to chloride and ethylene/ethane, chloroacetic acids and carbon dioxide gases, carbon tetrachloride and methylene chloride are transformed to chloride, methane and carbon dioxide, nitro aliphatic and nitroaromatics are denitrified to nitrogen gas, nitrite and organic anions such as formate and acetate.

Specifically, the present invention focuses on methods for cleaning metals and organic solvents adsorbed to tissues in aqueous solutions of hydrosulfite and persulfate (i.e., sulfur based bulk reductant and oxidant respectively) at ambient and high temperatures (40-90 degrees Celsius).

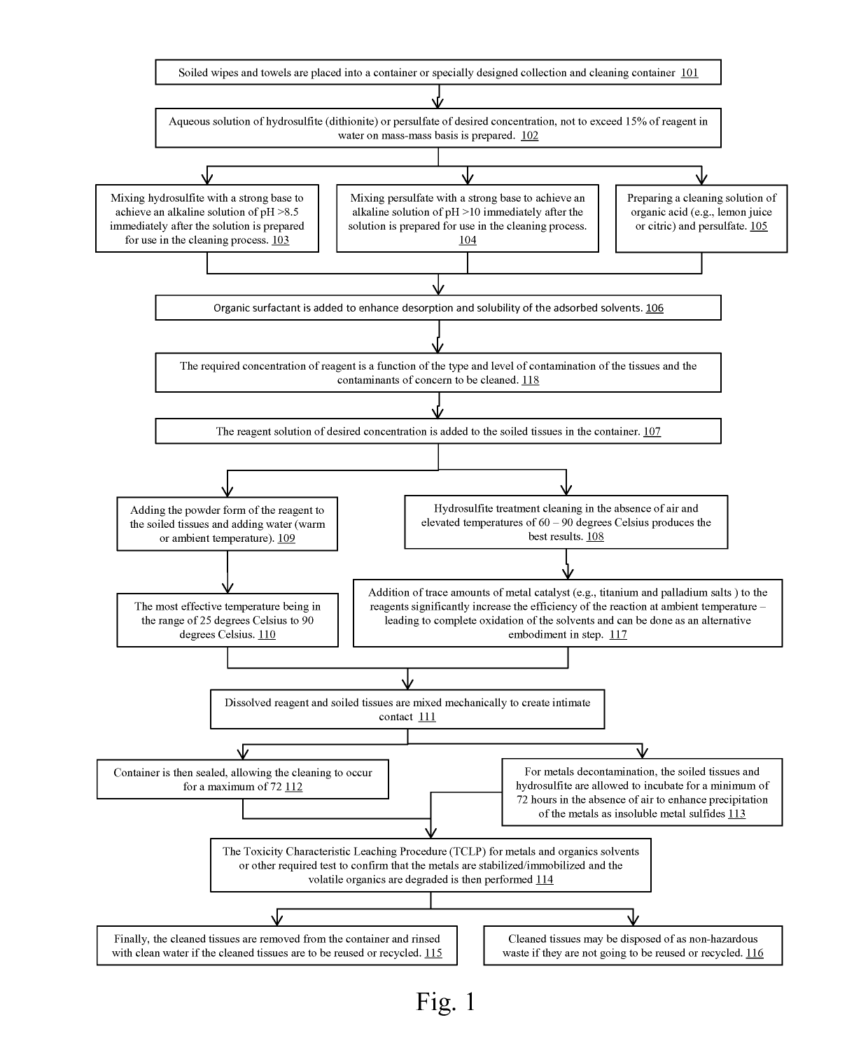

Now referring to FIG. 1, the cleaning process involves the following steps. In a first step, the soiled wipes and towels are placed into a container or specially designed collection and cleaning container 101. Next, an aqueous solution of hydrosulfite (dithionite) or persulfate of desired concentration, not to exceed 15% of reagent in water on mass-mass basis is prepared 102. In one embodiment, the desired reagent formulation is achieved by mixing hydrosulfite with a strong base to achieve an alkaline solution of pH>8.5 immediately after the solution is prepared for use in the cleaning process 103. The strong base may include alkali and/or alkaline earth metal hydroxides, oxides, carbonate, and bicarbonate.

In another embodiment the desired reagent formulation is achieved by mixing persulfate with a strong base to achieve an alkaline solution of pH>10 immediately after the solution is prepared for use in the cleaning process 104. The strong base may include alkali and/or alkaline earth metal hydroxides, oxides, carbonate, and bicarbonate.

In yet another embodiment the desired reagent formulation is achieved by preparing a cleaning solution of organic acid (e.g., lemon juice or citric) and persulfate 105.

In still another embodiment an organic surfactant is added to enhance desorption and solubility of the adsorbed solvents 106. The concentration of surfactant, for example Triton X 100, is less than 15% (V/V) of the aqueous phase. Biodegradable surfactants are preferred over the non-biodegradable surfactants.

The required concentration of reagent is a function of the type and level of contamination of the tissues and the contaminants of concern to be cleaned 106. Next, the reagent solution of desired concentration is added to the soiled tissues in the container 107.

For hydrosulfite treatment cleaning in the absence of air and elevated temperatures of 60-90 degrees Celsius produces the best results 108. Alternately, adding the powder form of the reagent to the soiled tissues and adding water (warm or ambient temperature) 109. The most effective temperature being in the range of 25 degrees Celsius to 90 degrees Celsius 110.

Next the dissolved reagent and soiled tissues are mixed mechanically to create intimate contact 111. The container is then sealed, allowing the cleaning to occur for a maximum of 72 hours 112. For metals decontamination, the soiled tissues and hydrosulfite are allowed to incubate for a minimum of 72 hours in the absence of air to enhance precipitation of the metals as insoluble metal sulfides 113.

Next, the Toxicity Characteristic Leaching Procedure (TCLP) for metals and organics solvents or other required test to confirm that the metals are stabilized/immobilized and the volatile organics are degraded is then performed 114. Finally, the cleaned tissues are removed from the container and rinsed with clean water if the cleaned tissues are to be reused or recycled. 115. Alternately, the cleaned tissues may be disposed of as non-hazardous waste 116 if they are not going to be reused or recycled.

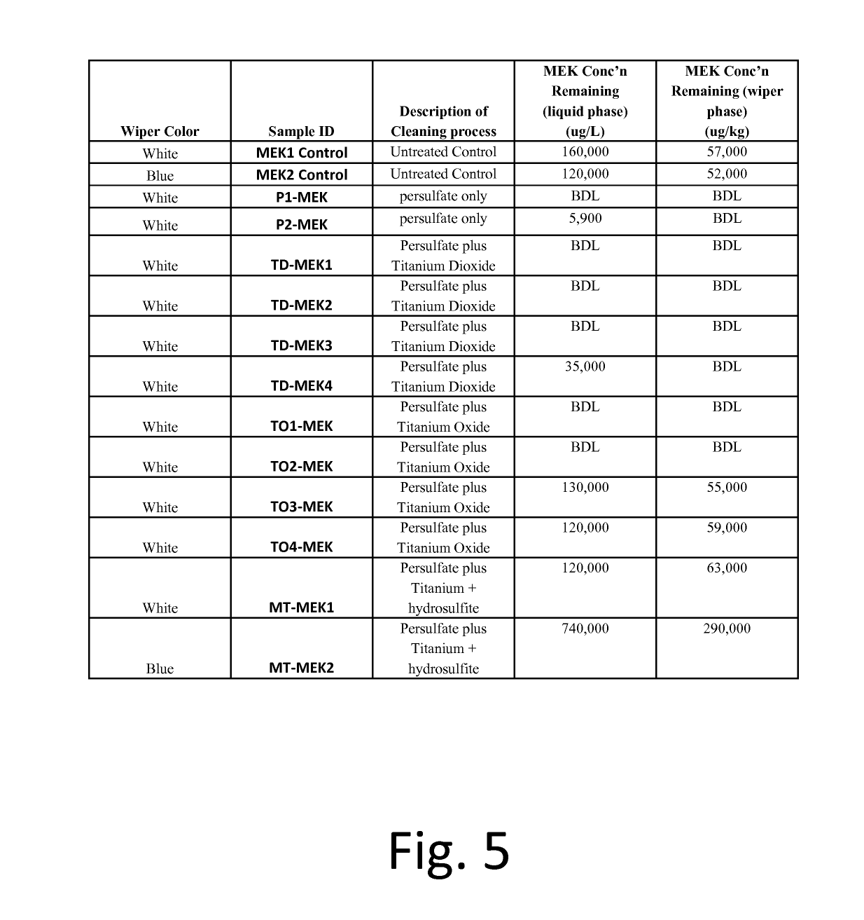

Additionally, ongoing tests results and unexpected results show that the addition of trace amounts of metal catalyst (e.g., titanium and palladium salts as shown in FIGS. 5-6) to the reagents significantly increase the efficiency of the reaction at ambient temperature—leading to complete oxidation of the solvents and can be done as an alternative embodiment in step 117.

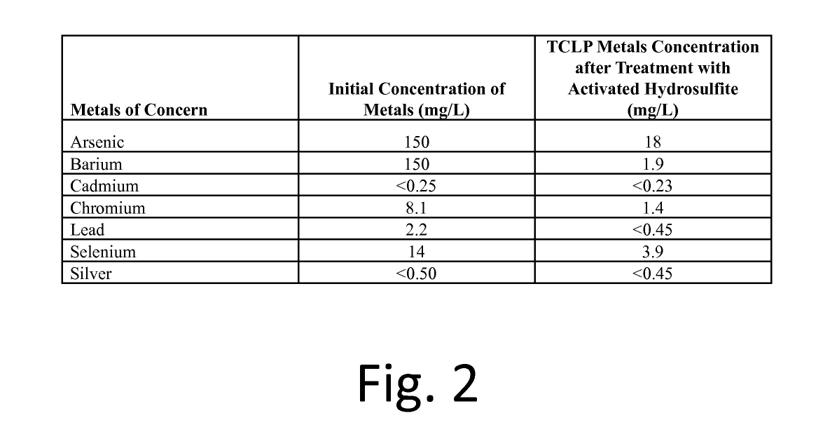

FIG. 2 is a table showing the experimental results of composite Industrial wipers (tissues) treated with 15% hydrosulfite solution at alkaline pH for 72 hours. The metals of concern were: arsenic, barium, cadmium, chromium, lead, selenium, and silver. In this experiment, composite tissues treated with 15% hydrosulfite solution at alkaline pH for 72 hours. The untreated controls were submitted for TCLP method analysis of the metals along with the hydrosulfite treated wipers. The initial concentrations of each of the metals of concern were determined using the untreated controls by a TCLP test or other equivalent test. The same TCLP analytical method was also followed for the soiled wipers treated for 72 hours with the 15% hydrosulfite solution at alkaline pH. The results show significant reduction in all leachable metal concentration levels for those metals identified as a concern.

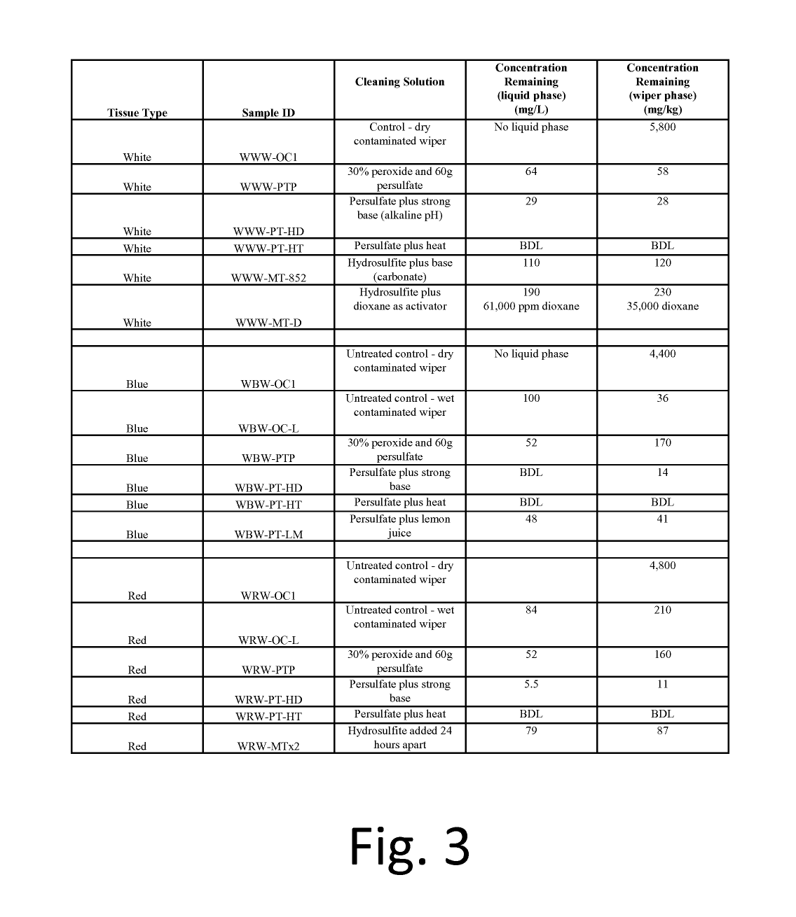

FIG. 3 is a table showing the experimental results of methyl ethyl ketone (MEK) contaminated tissues cleaned with different formulation of reagents with the goal of selecting a method(s) that achieve complete elimination of the solvent through destruction. In this experiment white, blue, and red industrial wipers were each contaminated with MEK and assigned a sample identification code. Each wiper was treated to eliminate the solvent in solution and wiper phase. As shown in the table of FIG. 3, the concentrations remaining in the liquid and solid phases in samples treated with persulfate at alkaline pH and persulfate solution at temperature above ambient (about 45 degrees Celsius) was most effective, especially when compared to the untreated controls for each wiper type where no liquid phase was performed (dry contaminated wiper) and where liquid phase was present (wet untreated controls). BDL in the tables stands for Below analytical method detection limit or below method detection concentration.

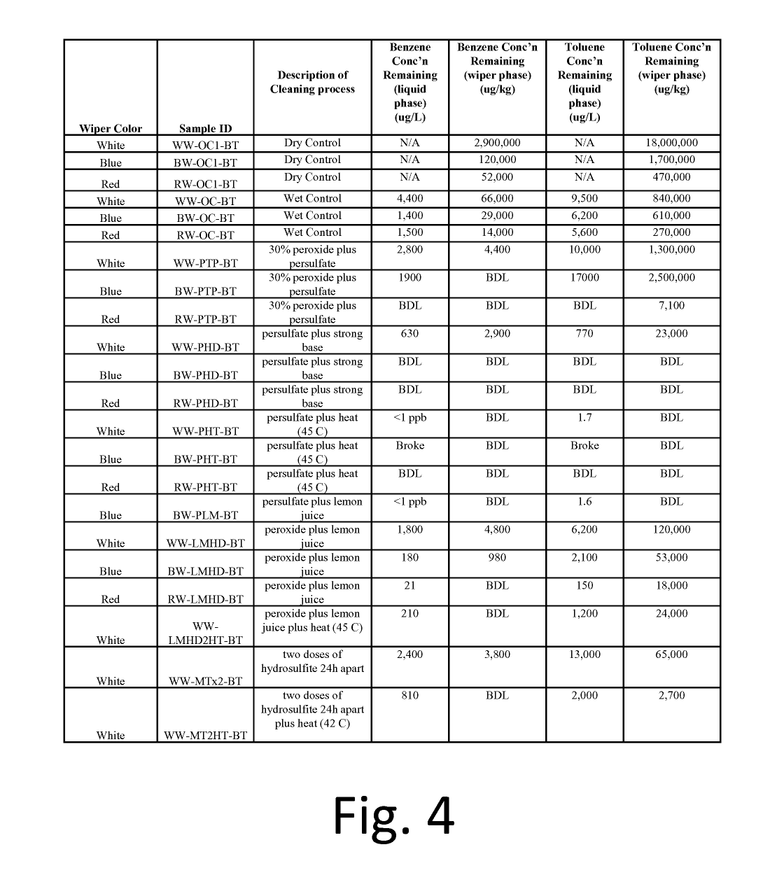

FIG. 4 is a table showing the cleaning of benzene and toluene contaminated industrial Wipers and associated experimental results. In these results you can see both dry and wet untreated control samples were analyzed for benzene and toluene to provide baseline concentrations for each cleaning process for comparison purposes. In the liquid phases, where applicable, initial concentration tests were run and measurements taken and recorded for each of the benzene and toluene liquid phases. The tests report before and after results of benzene and toluene levels based on the application of the de-contamination method of the present invention previously taught. At ambient temperature the cleaning solutions consisting of 30% peroxide plus persulfate; persulfate at alkaline pH and peroxide plus lemon juice (cheaper substitute for organic acid) were most effective in achieving complete elimination of benzene and toluene from the soil wipers. Meanwhile persulfate solution at above ambient temperature was most effective in cleaning the benzene and toluene contaminated wipers.

FIGS. 1-5 include details of the cleaning solutions and their effectiveness. The goal was to identify the most effective methods for cleaning the solvent contaminated wipers to achieve complete elimination. Although the methods were not optimized to achieve more efficient cleaning, the following treatments were directly effective or potentially promising: persulfate solution at alkaline pH; persulfate plus heat, persulfate plus trace amounts of trace metals (titanium, palladium); and peroxide plus organic acid (lemon juice or citric acid); hydrosulfite solution at pH>8.5 plus heat. FIG. 5 shows the results of each treatment and the cleaning solutions used. Thus, it is appreciated that the optimum dimensional relationships for the parts of the invention, to include variation in size, materials, shape, form, function, and manner of operation, assembly and use, are deemed readily apparent and obvious to one of ordinary skill in the art, and all equivalent relationships to those illustrated in the drawings and described in the above description are intended to be encompassed by the present invention.

Furthermore, other areas of art may benefit from this method and adjustments to the design are anticipated. Thus, the scope of the invention should be determined by the appended claims and their legal equivalents, rather than by the examples given.

The embodiments of the invention in which an exclusive property or privilege is claimed are defined as follows:

1. A method for cleaning metals and organic solvents adsorbed to tissues comprising the steps of:
placing the soiled tissues into a container or specially designed collection and cleaning container;
preparing an aqueous reagent formulation solution, not to exceed 15% of reagent in water on mass-mass basis;
calculating the required concentration of reagent as a function of the type and level of contamination of the tissues and the contaminants of concern to be cleaned;
adding the reagent solution of desired concentration to the soiled tissues in the container;
mixing the dissolved reagent and soiled tissues mechanically to create intimate contact;
sealing the container and allowing the cleaning to occur for a period of time; and
performing a Toxicity Characteristic Leaching Procedure (TCLP) for metals and organic solvents or other required test to confirm that the metals are stabilized/immobilized and the volatile organics are degraded.

2. The method of claim 1, wherein the desired reagent formulation is achieved by mixing hydrosulfite with a strong base to achieve an alkaline solution of pH>8.5 immediately after the solution is prepared for use in the cleaning process.

3. The method of claim 2, wherein the strong base may include alkali and/or alkaline earth metal hydroxides, oxides, carbonate, and bicarbonate.

4. The method of claim 1, wherein the desired reagent formulation is achieved by mixing persulfate with a strong base to achieve an alkaline solution of pH>10 immediately after the solution is prepared for use in the cleaning process.

5. The method of claim 4, wherein the strong base may include alkali and/or alkaline earth metal hydroxides, oxides, carbonate, and bicarbonate.

6. The method of claim 1, wherein the desired reagent formulation is achieved by preparing a cleaning solution of organic acid and persulfate.

7. The method of claim 6 wherein the organic acid is lemon juice or citric acid.

8. The method of claim 1, further comprising the step of:
adding an organic surfactant to enhance desorption and solubility of the adsorbed solvents.

9. The method of claim 8, wherein the concentration of the surfactant is less than 15% (V/V) of the aqueous phase.

10. The method of claim 8, wherein the surfactant is biodegradable.

11. The method of claim 8, wherein the surfactant is non-biodegradable.

12. The method of claim 2, further comprising the step of
controlling the temperature between 60 and 90 degrees Celsius in the absence of air.

13. The method of claim 2, further comprising the step of
adding the powder form of the reagent to the soiled tissues; and
adding water at or above ambient temperature.

14. The method of claim 13, further comprising the step of
controlling the temperature between 25 degrees Celsius to 90 degrees Celsius.

15. The method of claim 8, wherein the cleaning occurs for a maximum period of 72 hours.

16. The method of claim 2 further comprising the step of
allowing the soiled tissues and hydrosulfite to incubate for a minimum of 72 hours in the absence of air to enhance precipitation of the metals as insoluble metal sulfides for metals decontamination.

17. The method of claim 1 further comprising the step of
removing the cleaned tissues from the container and rinsing with clean water if the cleaned tissues are to be reused or recycled.

18. The method of claim 1 further comprising the step of
disposing the cleaned tissues as non-hazardous waste.

19. The method of claim 1 further comprising the step of
adding trace amounts of metal catalyst to the reagents significantly increasing the efficiency of the reaction at ambient temperature leading to complete oxidation of the solvents.

20. The method of claim 19 wherein the metal catalyst is a titanium oxide and palladium salts.
